(19) United States
(12) Patent Application Publication
(10) Pub. No.: US 2023/0245013 A1
(43) Pub. Date: Aug. 3, 2023

(54) SYSTEM AND METHOD FOR RECOMMENDING INDIVIDUALS FOR OPEN ROLES

(71) Applicants: John Baker, Kitchener (CA); Brian Cepuran, Kitchener (CA); Jeremy Auger, Kitchener (CA)

(72) Inventors: John Baker, Kitchener (CA); Brian Cepuran, Kitchener (CA); Jeremy Auger, Kitchener (CA)

(21) Appl. No.: 18/103,657

(22) Filed: Jan. 31, 2023

Related U.S. Application Data
(60) Provisional application No. 63/304,977, filed on Jan. 31, 2022.

(51) Int. Cl. G06Q 10/0631; G06Q 10/105; G06Q 50/20

(52) U.S. Cl. CPC G06Q 10/063112; G06Q 10/105; G06Q 50/2057

(57) ABSTRACT

A system for recommending individuals for open roles includes one or more computing devices and a server that communicate over a network. The server is configured to store information for the system, the information including at least one of organization data, user data and historical information pertaining to individuals that followed pre-determined paths or developed pre-determined competencies; and implement at least an analytics engine. The analytics engine is configurable to: determine an organizational need; determine a set of one or more individuals that could thrive in a role targeted to the determined organization need; and generate a recommendation of individuals suitable for roles targeted to the organizational need based in part on the analysis of the organizational need and the set of one or more individuals.

### CROSS-REFERENCE TO RELATED APPLICATIONS

This application claims the benefit of U.S. Provisional Pat. Application No. 63/304,977 filed on Jan. 31, 2022. The entire contents of U.S. Provisional Pat. Application No. 63/304,977 are hereby incorporated herein by reference for all purposes.

### TECHNICAL FIELD

The embodiments herein relate to the fields of electronic learning and human resources technologies, and, in particular, to systems and methods for recommending individuals for open roles.

### BACKGROUND

Electronic learning (also called e-Learning or eLearning) generally refers to education or learning where users engage in education related activities using computers and other computer devices. For examples, users may enroll or participate in a course or program of study offered by an educational institution (e.g., a college, university or grade school) through a web interface that is accessible over the Internet. Similarly, users may receive assignments electronically, participate in group work and projects by collaborating online, and be graded based on assignments and examinations that are submitted using an electronic dropbox.

Electronic learning is not limited to use by educational institutions, however, and may also be used in governments or in corporate environments. For example, employees at a regional branch office of a particular company may use electronic learning to participate in a training course offered by their company’s head office without ever physically leaving the branch office.

Electronic learning can also be an individual activity with no institution driving the learning. For example, individuals may participate in self-directed study (e.g., studying an electronic textbook or watching a recorded or live webcast of a lecture) that is not associated with a particular institution or organization.

Electronic learning often occurs without any face-to-face interaction between the users in the educational community. Accordingly, electronic learning overcomes some of the geographic limitations associated with more traditional learning methods, and may eliminate or greatly reduce travel and relocation requirements imposed on users of educational services.

Electronic learning can be useful for people trying to further their careers. For example, an individual can use electronic learning to acquire technical and soft skill competencies necessary to excel within the evolving job market. An individual can also use electronic learning to acquire skills addressing a gap in the market.

Certain human resources technologies may offer different kinds of recruiting tests, including personality assessments and knowledge-based tests when hiring for new positions. But such technologies may not be based on the functionality and purposes of a job opening. Also, such technologies may not take into account a candidate’s prior education or competencies and/or historical information pertaining to others that followed similar paths or developed similar competencies.

However, these technologies may not be suitable to identify organizational needs based, for example, on business opportunities and/or organization data. Further, such technologies may not be able to identify a set of one or more individuals that could thrive in a role targeted to the organizational needs.

Accordingly, the inventors have identified a need for systems, methods, and apparatuses that attempt to address at least some of the above-identified challenges.

### SUMMARY

According to a broad aspect, there is provided a system for recommending individuals for open roles, including: one or more computing devices that communicate over a network with the system, at least one computing device comprising a graphical user interface for providing data to the system and outputting data to a user; a server. The server is configured to: communicate with the one or more computing devices; store information for the system, the information including at least one of organization data, user data and historical information pertaining to individuals that followed pre-determined paths or developed pre-determined competencies; and implement at least an analytics engine The at least one analytics engine is configurable to: determine an organizational need based at least on the organization data; determine a set of one or more individuals that could thrive a role targeted to the determined organization need based at least on the user data; analyze the organizational need and the set of one or more individuals to generate a recommendation of individuals for roles based on characteristics pertaining to the individual, and historical information pertaining to others that followed similar paths or developed similar competencies; and generate the recommendation of individuals suitable for roles targeted to the organizational need based in part on the analysis of the organizational need and the set of one or more individuals; and provide the recommendation to the at least one computing device.

For example, the analytics engine can include a trained model that is trained using at least one of: personal profile of an individual, including role, interests, background education, competencies, competency gaps; information from third parties including universities, the information indicating what programs lead into certain skills; crowd sourcing tagging of skills and competencies; internet sources using semantic analysis; information pertaining to skill gaps at industry level; and organizational competencies, including needs versus competencies of current personnel.

For example, the trained model can include at least one of: a probabilistic model, a regression model, or a stochastic model.

For example, the probabilistic model can recommend individuals for roles based on characteristics pertaining to the individual, and historical information pertaining to others that followed similar paths or developed similar competencies.

For example, the server can be configured to train the model using historical data.

For example, the server can be further configured to output a confidence score indicating a confidence that a set of one or more individuals may fill a need of the organization based on a statistical analysis of extent of overlap between competencies and interests of the one or more individuals and the needs of the organization.

For example, the server can be further configured to find individuals having a competency gap that is less than a pre-determined threshold.

According to a broad aspect, there is provided a system a method for recommending individuals for open roles, the method including: implementing at least an analytics engine; determining, using the analytics engine, an organizational need based at least on the organization data; determining, using the analytics engine, a set of one or more individuals that could thrive a role targeted to the determined organization need based at least on the user data; analyzing, using the analytics engine, the organizational need and the set of one or more individuals to generate a recommendation of individuals for roles based on characteristics pertaining to the individual, and historical information pertaining to others that followed similar paths or developed similar competencies; generating, using the analytics engine, the recommendation of individuals suitable for roles targeted to the organizational need based in part on the analysis of the organizational need and the set of one or more individuals; and providing the recommendation to the at least one computing device.

For example, the analytics engine can include a trained model that is trained using at least one of: personal profile of an individual, including role, interests, background education, competencies, competency gaps; information from third parties including universities, the information indicating what programs lead into certain skills; crowd sourcing tagging of skills and competencies; internet sources using semantic analysis; information pertaining to skill gaps at industry level; and organizational competencies, including needs versus competencies of current personnel.

For example, the trained model can include at least one of: a probabilistic model, a regression model, and/or a stochastic model.

For example, the probabilistic model can recommend individuals for roles based on characteristics pertaining to the individual, and historical information pertaining to others that followed similar paths or developed similar competencies.

For example, the server can be configured to train the model using historical data.

For example, the server can be further configured to output a confidence score indicating a confidence that a set of one or more individuals may fill a need of the organization based on a statistical analysis of extent of overlap between competencies and interests of the one or more individuals and the needs of the organization.

For example, the server can be further configured to find individuals having a competency gap that is less than a pre-determined threshold.

Other aspects and features will become apparent to those ordinarily skilled in the art upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 shows a schematic diagram of components interacting within a system for recommending individuals for open roles in accordance with some embodiments; and

FIG. 2 shows a flowchart diagram of a method for recommending individuals for open roles in accordance with some embodiments.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present subject matter.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device / article (whether or not they cooperate) may be used in place of a single device / article. Similarly, where more than one device or article is described herein (whether or not they cooperate), it will be readily apparent that a single device / article may be used in place of the more than one device or article.

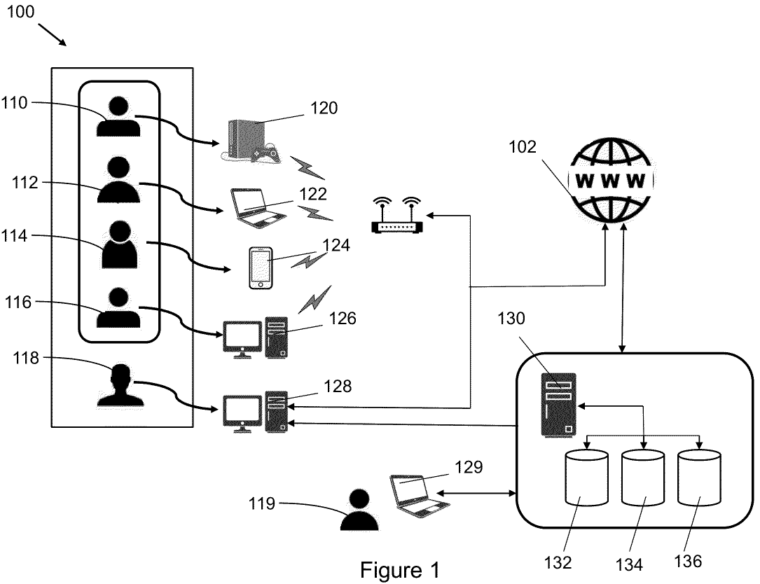

Referring now to FIG. 1, there is shown a schematic diagram of components interacting within a system 100 in accordance with some embodiments. The system can be part of an electronic learning program or part of a human resources system. The system 100 may be particularly configured for recommending individuals for open roles.

The system 100 includes computing devices 120, 122, 124, 126, 128, 129 that communicate over a network 102 with the system 100. The computing devices can include a graphical user interface for providing data to the system and outputting data to users 110, 112, 114, 116, 118, 119 respectively.

The system 100 includes a server 130 configured to communicate with the one or more computing devices 120, 122, 124, 126, 128, 129 over the network 102.

The server 130 can store data on storage devices 132, 134, 136. The data can include at least one organization data, user data and historical information pertaining to individuals that followed pre-determined paths or developed pre-determined competencies.

The server 130 can implement an analytics engine. The analytics engine represents any engine that can perform operations related to understanding, interpretation of, and actions performed related to a set of received data inputs. The analytics engine can determine an organizational need based at least on the organization data; determine a set of one or more individuals that could thrive in a role targeted to the determined organization need based at least on the user data; analyze the organizational need and the set of one or more individuals to generate a recommendation of individuals for roles based on characteristics pertaining to the individual, and historical information pertaining to others that followed similar paths or developed similar competencies; and generate the recommendation of individuals suitable for roles targeted to the organizational need based in part on the analysis of the organizational need and the set of one or more individuals. For example, the analytics engine can recommend individuals for the roles based on characteristics pertaining to the individual, and historical information pertaining to others that followed similar paths or developed similar competencies.

The analytics engine can, in some instances, also generate UI elements and/or graphics data to provide to a user corresponding to the client device. Examples of the analytics engine that could be used or implemented include a plurality of web services and backend applications, including IBM’s Watson, Google Cloud Natural Language API, Amazon Lez, Microsoft Cognitive Services, as well as any proprietary solution, application, or service. The processing performed by the analytics engine can include processing the received inputs identifying a context.

The analytics engine can provide the recommendation to the at least one computing device 120, 122, 124, 126, 128, 129. The analytics engine can include a trained computer (AI) model that is trained over time with historical data to determine the role and/or opportunity for the user and to recommend individuals for roles. The trained model can include at least one of: a probabilistic model, a regression model, and/or a stochastic model. The probabilistic model can recommend individuals for roles based on characteristics pertaining to the individual, and historical information pertaining to others that followed similar paths or developed similar competencies.

The analytics engine can include a trained model that is trained using at least one of: personal profile of an individual, including role, interests, background education, competencies, competency gaps; information from third parties including universities, the information indicating what programs lead into certain skills; crowd sourcing tagging of skills and competencies; internet sources using semantic analysis; information pertaining to skill gaps at industry level; and organizational competencies, including needs versus competencies of current personnel. All the above data can be stored in any one of the data storage devices 132, 134, 136.

The artificial intelligence (AI) model can include at least one of: a probabilistic model, a regression model, and/or a stochastic model. The probabilistic model can recommend individuals for roles based on characteristics pertaining to the individual, and historical information pertaining to others that followed similar paths or developed similar competencies. The server 130 can be configured to train the model using historical data. The server 130 can be further configured to output a confidence score indicating a confidence that a set of one or more individuals may fill a need of the organization based on a statistical analysis of extent of overlap between competencies and interests of the one or more individuals and the needs of the organization. The server 130 can be further configured to find individuals having a competency gap that is less than a pre-determined threshold.

Advantageously, the system 100 can determine an organizational need and a set of one or more individuals that could thrive in a role targeted to the need. Further, the system can determine a set of one or more users that fill a need of the organization based on a statistical analysis of extent of overlap between competencies/interests of individual(s) and needs of an organization. The system can advantageously find individuals having a competency gap that is less than a (configurable) threshold. For individuals that do not have all competencies (or at least core competencies) to a role, the system can deem them as good enough. For individuals that are deemed good enough, the system can further recommend the promotion to the role in connection with a personalized pathway to assist the individual in attaining the competencies of the gap.

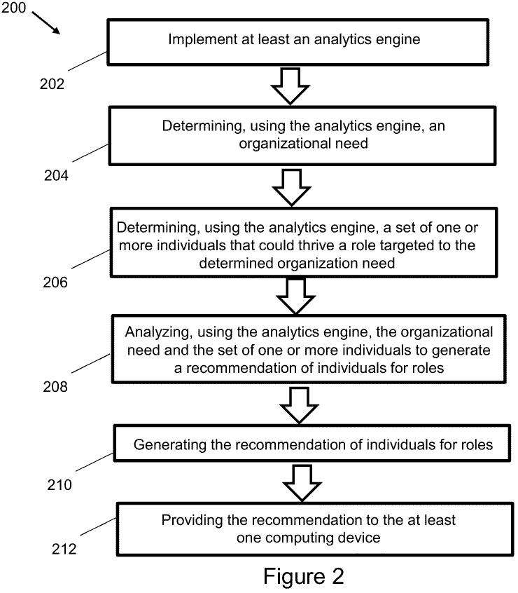

Referring now to FIG. 2, there is shown a method 200 for recommending individuals for open roles. At 202, the method includes implementing at least an analytics engine. The analytics engine can analyze information and generate various reports or recommendations which relate to statistical information and trends. The reports contain or are based on correlation data which the analytics engine has identified as being statistically relevant. The method uses the analytics engine to accomplish the various steps described below. The analytics engine can be any engine that can perform operations related to understanding, interpretation of, and actions performed related to a set of received inputs. The analytics engine can, in some instances, also generate UI elements and/or graphics data to provide to a user corresponding to the client device. Examples of the analytics engine that could be used or implemented include a plurality of web services and backend applications, including IBM’s Watson, Google Cloud Natural Language API, Amazon Lez, Microsoft Cognitive Services, as well as any proprietary solution, application, or service.

At 204, the method includes determining, using the analytics engine, an organizational need based at least on the organization data. At 206, the method includes determining, using the analytics engine, a set of one or more individuals that could thrive in a role targeted to the determined organization need based at least on the user data.

At 208, the method includes analyzing, using the analytics engine, the organizational needs and the set of one or more individuals to generate a recommendation of individuals for roles based on characteristics pertaining to the individual, and historical information pertaining to others that followed similar paths or developed similar competencies.

At 210, the method includes generating, using the analytics engine, the recommendation of individuals suitable for roles targeted to the organizational need based in part on the analysis of the organizational need and the set of one or more individuals. At 212, the method includes providing the recommendation to the at least one computing device.

The analytics engine can include an AI trained model that is trained using at least one of: personal profile of an individual, including role, interests, background education, competencies, competency gaps; information from third parties including universities, the information indicating what programs lead into certain skills; crowd sourcing tagging of skills and competencies; internet sources using semantic analysis; information pertaining to skill gaps at industry level; and organizational competencies, including needs versus competencies of current personnel.

The trained model can include at least one of: a probabilistic model, a regression model, or a stochastic model. The probabilistic model is adapted to recommend individuals for roles based on characteristics pertaining to the individual, and historical information pertaining to others that followed similar paths or developed similar competencies. The model can be trained using historical data. The analytics engine can output a confidence score indicating a confidence that a set of one or more individuals may fill a need of the organization based on a statistical analysis of extent of overlap between competencies and interests of the one or more individuals and the needs of the organization. The analytics engine can find individuals having a competency gap that is less than a pre-determined threshold.

1. A system for recommending individuals for open roles, comprising:
one or more computing devices that communicate over a network with the system, at least one computing device comprising a graphical user interface for providing data to the system and outputting data to a user;
a server configured to:
communicate with the one or more computing devices;
store information for the system, the information including at least one of organization data, user data and historical information pertaining to individuals that followed pre-determined paths or developed pre-determined competencies;
implement at least an analytics engine, wherein the at least one analytics engine is configurable to:
determine an organizational need based at least on the organization data;
determine a set of one or more individuals that could thrive in a role targeted to the determined organization need based at least on the user data;
analyze the organizational need and the set of one or more individuals to generate a recommendation of individuals for roles based on characteristics pertaining to the individual, and historical information pertaining to others that followed similar paths or developed similar competencies; and
generate the recommendation of individuals suitable for roles targeted to the organizational need based in part on the analysis of the organizational need and the set of one or more individuals; and provide the recommendation to the at least one computing device.

2. The system of claim 1, wherein the analytics engine comprises a trained model that is trained using at least one of:
personal profile of an individual, including role, interests, background education, competencies, competency gaps;
information from third parties including universities, the information indicating what programs lead into certain skills;
crowd sourcing tagging of skills and competencies;
internet sources using semantic analysis;
information pertaining to skill gaps at industry level; and
organizational competencies, including needs versus competencies of current personnel.

3. The system of claim 2, wherein the trained model comprises at least one of: a probabilistic model, a regression model, or a stochastic model.

4. The system of claim 3, wherein the probabilistic model is adapted to recommend individuals for roles based on characteristics pertaining to the individual, and historical information pertaining to others that followed similar paths or developed similar competencies.

5. The system of claim 2, wherein the server is configured to train the model using historical data.

6. The system of claim 1, wherein the server is further configured to output a confidence score indicating a confidence that a set of one or more individuals may fill a need of the organization based on a statistical analysis of extent of overlap between competencies and interests of the one or more individuals and the needs of the organization.

7. The system of claim 1, wherein the server is further configured to find individuals having a competency gap that is less than a pre-determined threshold.

8. A method for recommending individuals for open roles, the method comprising:
implementing at least an analytics engine;
determining, using the analytics engine, an organizational need based at least on the organization data;
determining, using the analytics engine, a set of one or more individuals that could thrive in a role targeted to the determined organization need based at least on the user data;
analyzing, using the analytics engine, the organizational needs and the set of one or more individuals to generate a recommendation of individuals for roles based on characteristics pertaining to the individual, and historical information pertaining to others that followed similar paths or developed similar competencies;
generating, using the analytics engine, the recommendation of individuals suitable for roles targeted to the organizational need based in part on the analysis of the organizational need and the set of one or more individuals; and
generating the recommendation of individuals based on the analysis of the organizational need and the set of one or more individuals
providing the recommendation to the at least one computing device.

9. The method of claim 8, wherein the analytics engine comprises a trained model that is trained using at least one of:
personal profile of an individual, including role, interests, background education, competencies, competency gaps;
information from third parties including universities, the information indicating what programs lead into certain skills;
crowd sourcing tagging of skills and competencies;
internet sources using semantic analysis;
information pertaining to skill gaps at industry level; and
organizational competencies, including needs versus competencies of current personnel.

10. The method of claim 9, wherein the trained model comprises at least one of: a probabilistic model, a regression model, or a stochastic model.

11. The method of claim 10, wherein the probabilistic model is adapted to recommend individuals for roles based on characteristics pertaining to the individual, and historical information pertaining to others that followed similar paths or developed similar competencies.

12. The method of claim 9, wherein the server is configured to train the model using historical data.

13. The method of claim 8, wherein the server is further configured to output a confidence score indicating a confidence that a set of one or more individuals may fill a need of the organization based on a statistical analysis of extent of overlap between competencies and interests of the one or more individuals and the needs of the organization.

14. The method of claim 8, wherein the server is further configured to find individuals having a competency gap that is less than a pre-determined threshold.
